(19) United States
(12) Patent Application Publication
(10) Pub. No.: US 2008/0057954 A1
(43) Pub. Date: Mar. 6, 2008

(54) SOFTER CLUSTERING OF REMOTE BASE ANTENNAS

(75) Inventor: William K. Morgan, Wauconda, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/468,347

(22) Filed: Aug. 30, 2006

(51) Int. Cl. H04Q 7/20

(52) U.S. Cl. 455/435.1

(57) ABSTRACT

A cell handoff signal processing system (200) including Base Transceiver System channel elements (204, 206) that receive multiple RF signals corresponding to a common RF signal containing user data transmitted by a wireless communications device (104). The multiple RF signals are received by antennas associated with different communications cells (230, 232) that are located at geographically separated antenna towers (120a, 120b). The at least one single base transceiver channel element (204) receives RF signals from geographically separated antenna towers (120a, 120b) through cell to channel element link (260) and simultaneously processes these multiple RF signals that were received at the geographically separated antenna towers (120a, 120b) so as to extract the user data transmitted by the wireless communications device (104).

### CROSS-REFERENCE TO RELATED APPLICATION

Not Applicable

### FIELD OF THE INVENTION

The present invention generally relates to the field of wireless base station handoff processing, and more particularly relates to processing of wireless unit handoff between different antennas that are processed by a common processor.

### BACKGROUND OF THE INVENTION

Communications systems, such as Code Division, Multiple Access (CDMA) based communications systems, benefit from improvements in capacity, accumulating call statistics and general costs reductions. One area of high resource utilization is the monitoring and/or maintaining of multiple wireless links to support handing off a mobile wireless device between different cells as the mobile wireless device moves between cells.

Communications systems are able to improve handoff performance by using so-called “soft handoffs.” Soft handoffs involve using RF resources, including antennas and dedicated channel element receivers, for multiple communications cells to receive and process RF transmissions from a single mobile wireless device. These RF resources for each communications cell are then synchronized with the mobile wireless device and are ready to perform primary communications with that mobile wireless device. As the mobile wireless device that is communicating with a particular cell moves to a location where a better wireless communications link is available with another communications cell, the mobile wireless device can be readily assigned to the other communications cell with minimum disruption. Assigning the RF resources of multiple cells to a single mobile wireless device, however, consumes additional RF resources and other infrastructure processing, such as backhaul communications resources, as compared to the resources than are minimally required for communications. Some individual base stations incorporate softer handoff processing of signals between sectors that all have antennas located at that same antenna tower. The softer handoff processing provides the RF signals received by multiple antennas at the single antenna tower to a RAKE receiver to support handing off signals between cells with antennas at the same antenna tower.

Therefore a need exists to overcome the problems with the prior art as discussed above.

### SUMMARY OF THE INVENTION

Briefly, in accordance with one aspect of the present invention a method for processing transmitted signals from a wireless communication device that are received at geographically separated antenna towers includes receiving a first RF signal with at least one first antenna that is associated with a first cell. The first antenna is located at a first antenna tower. The method further includes receiving a second RF signal with at least one second antenna associated with a second cell. The second antenna is located at a second antenna tower that is geographically separated from the first antenna tower. The first RF signal and the second RF signal correspond to a common RF signal containing user data transmitted by a wireless communications device. The method also includes coupling the first RF signal and the second RF signal to a single Base Transceiver System channel element and simultaneously processing, at the single Base Transceiver System channel element, the first RF signal and the second RF signal so as to extract the user data transmitted by the wireless communications device.

In accordance with another aspect of the present invention, a cell handoff signal processing system includes a first cell interface that is adapted to receive a first RF signal that was received by at least one first antenna. The first antenna is associated with a first cell and is located at a first antenna tower. The cell handoff signal processing system also includes a second cell interface adapted to receive a second RF signal that was received by at least one second antenna associated with a second cell. The second antenna is located at a second antenna tower that is geographically separated from the first antenna tower. The first RF signal and the second RF signal correspond to a common RF signal containing user data transmitted by a wireless communications device. The cell handoff signal processing system further includes at least one single base transceiver channel element that is coupled to the first cell interface and the second cell interface. The at least one single base transceiver channel element is adapted to simultaneously process the first RF signal and the second RF signal so as to extract the user data transmitted by the wireless communications device.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a multiple antenna tower communications system in accordance with one embodiment of the present invention;

FIG. 2 illustrates a signal processing configuration diagram in accordance with one embodiment of the present invention;

FIG. 3 illustrates a processing flow diagram for a handoff configuration process in accordance with one embodiment of the present invention;

FIG. 4 illustrates a message exchange diagram in accordance with one embodiment of the present invention; and

FIG. 5 illustrates a block diagram of a Radio Network Controller (RNC) data processing node, in accordance with one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as illustrative examples for the claims and as a representative basis for teaching one skilled in the art to variously employ the present invention in virtually any appropriately detailed structure. Further, the terms and phrases used herein are not intended to be limiting; but rather, to provide an understandable description of embodiments of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

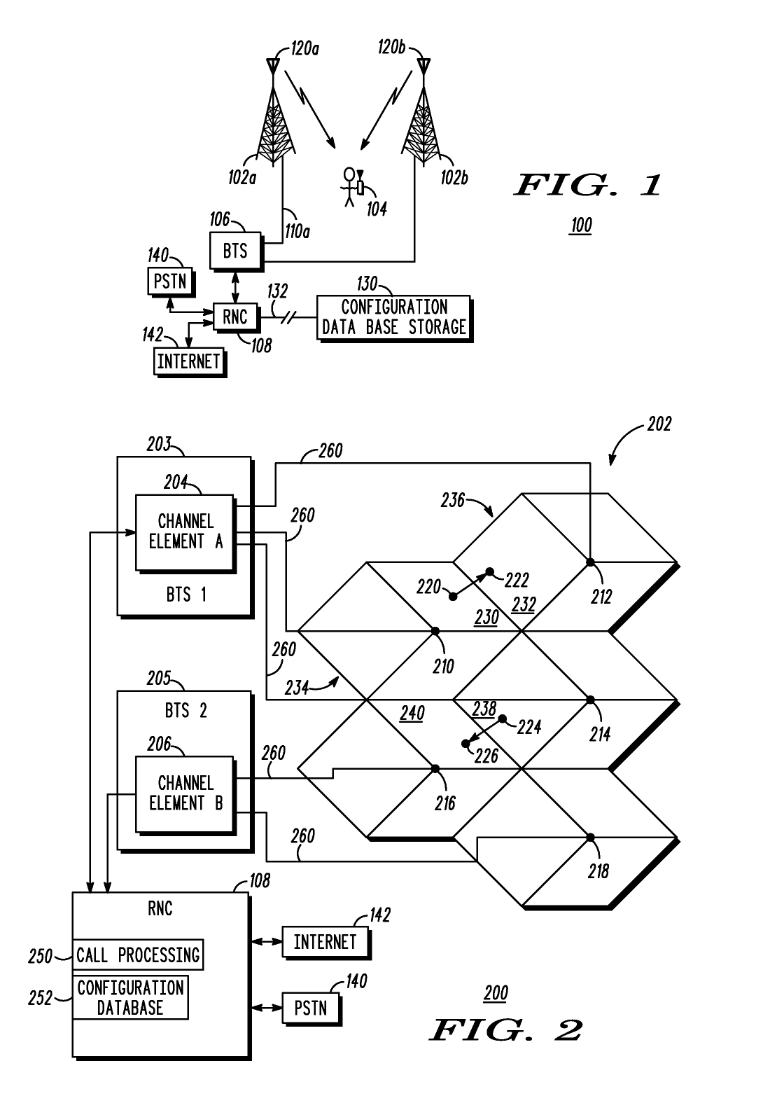

FIG. 1 illustrates a multiple antenna tower communications system 100 in accordance with one embodiment of the present invention. The illustrated multiple antenna tower communications system 100 shows two antenna towers, antenna tower A 102a and antenna tower B 102b. Although two antenna towers are shown to simplify the present discussion and facilitate illustration of the key features of one embodiment of the present invention, it is understood that the multiple antenna tower communications system 100 is able to operate with any number of antenna towers that are appropriately interconnected. Further, antenna “towers” in various embodiments of the present invention are able to include various structures, such as a building roof, water tower, and so forth, on which one or more antennas are mounted.

Each antenna tower is able to have one or more antennas. As is known to one of ordinary skill in the relevant arts, an antenna tower is able to have either an omni-directional antenna or one or more directional antennas with receive and transmit patterns defining one or more sectors or cells. An omni-directional antenna is able to provide one cell that has the antenna tower located at the cell's center. Some communications systems divide the area around an antenna tower into, for example, three (3) or six (6) sectors, or cells. A separate, directional communications antenna is then assigned to each of these cells in order to receive and transmit RF signals to communicate with wireless communications devices located in the respective cells.

A wireless communications device 104 is able to wirelessly communicate with one or more antenna towers of the multiple antenna tower communications system 100. Operation of communications systems generally include antenna towers, such as antenna tower A 102a and antenna tower B 102b, that transmit a pilot signal for each sector or cell. Wireless communications devices 104 are able to receive and measure the received signal strength of these pilot signals. The pilot signals from the various cells are differentiated to allow the wireless communications device 104 to identify which cell is associated with a particular pilot signal. In the case of Code Division Multiple Access (CDMA) systems, each pilot signal is identified with a separate Pseudo-Noise (PN) spreading code. The operation of some of these systems includes the wireless communications device 104 reporting to a central controller that a pilot signal has been received from a particular cell along with a measured signal strength of the pilot signal received by the receiver of the wireless communications device 104. The central controller is then able to determine if the cell associated with this received pilot signal qualifies to be added as a handoff candidate for the wireless communications device 104.

RF signals received and transmitted by the antennas associated with the cells of the antenna towers are processed and/or generated by channel elements within one or more Base Transceiver Systems (BTS) 106. The signals received by the communications antenna or antennas located at antenna tower A 102a are communicated to the BTS 106 through a first station-to-BTS RF link 110a. The signals received by the communications antenna or antennas located at antenna tower B 102b are communicated to the BTS 106 through a second station-to-BTS RF link 110b. The two station-to-BTS RF links of this embodiment include fiber optic links to communicate RF signals directly to the BTS 106, which is remotely located from each antenna tower in some embodiments. Other embodiments incorporate RF based wireless station to BTS RF links between the antenna tower and the BTS 106. In some embodiments of the present invention, the BTS 106 is able to be collocated with one of the antenna towers. One BTS 106 is illustrated for clarity and to facilitate understanding of the elements of the present invention. Some embodiments of the present invention include multiple BTS 106 that are able to be collocated with each other or geographically disperse.

The BTS 106 of one embodiment of the present invention, which incorporates CDMA communications between the antenna towers and the wireless communications device 104, have one or more channel elements that include one or more RAKE receivers. As is known to one of ordinary skill in the relevant arts, RAKE receivers process a received signal with multiple correlators to simultaneously process received CDMA signals that have different spreading code time offsets. Conventional RAKE receivers are used to process different multipath components of a CDMA signal received through one antenna or multiple, generally collocated, antennas. As described below, the present invention advantageously uses a RAKE receiver to simultaneously process CDMA signals received by geographically disperse antennas that are located at different antenna towers in order to more efficiently perform handoff processing between cells. Further embodiments of the present invention are able to incorporate any suitable receiver that is able to process temporally disperse versions of received signals.

The BTS 106 communicates with a Radio Network Controller (RNC) 108. In one embodiment, the RNC 108 includes a control function that controls wireless communications between antenna towers 120a, 120b and wireless communications devices 104. In addition to controlling connection of voice and/or digital communications between the wireless communications device 104 and remote voice and/or data sources, the RNC 108 further controls with which cell a wireless communications device 104 is assigned to communicate. By being assigned to a cell, the antenna associated with the assigned cell is used to transmit signals to the wireless communications device 104. The RNC 108 further maintains the selection of antenna tower handoff candidates for particular wireless communications devices 104 and implements handoff processing. As described below, the RNC 108 of one embodiment is configured to implement the additional processing associated with the softer handoffs of the present invention in order to more efficiently process handing off the assignment of the wireless communications device to another cell.

The RNC 108 of this embodiment of the present invention communicates with a configuration database storage 130 through a network link 132. The configuration database storage 130 stores system configuration data used to support the operation of the multiple antenna tower communications system 100, as is described in detail below. The RNC 108 of this embodiment is in further communications with the Public Switched Telephone Network (PSTN) 140 and data communications networks, such as the example of the Internet 142. The connections to the PSTN 140 and Internet 142 allow the wireless communications device 104 to perform voice and/or data communications. Connections between the RNC 108 and other internal and/or external communications networks, which allow the wireless communications device 104 to communicate with other end users through those networks, are included in further embodiments of the present invention.

FIG. 2 illustrates a signal processing configuration diagram 200 in accordance with one embodiment of the present invention. The illustrated signal processing configuration diagram 200 includes a geographical cell radio coverage depiction 202 showing a number of three-cell hexagons that generally represent the geographical coverage of cells of a radio network. Examples of these three cell hexagons are a first three cell hexagon 234 and a second three cell hexagon 236. Each of the illustrated three-cell hexagons has an antenna tower at its center, such as a first antenna tower 210 located at the center of the first three-cell hexagon 234 and a second antenna tower 212 located at the center of the second three cell hexagon 236. Further embodiments include different cell coverage patterns for one or more antenna towers, such as having one cell centered at an antenna tower, and cell divisions that include two, six or other numbers of sectors created by directional antennas located an antenna tower. Further three-cell hexagons are shown in the geographical cell radio coverage depiction 202 as centered at a third antenna tower 214, a fourth antenna tower 216 and a fifth antenna tower 218, respectively. Some embodiments of the present invention are able to operate with any number of antenna towers with sectors defined by any practical division for each antenna tower. Each of these antenna towers, e.g., the first antenna tower 210 and the second antenna tower 212, are geographically separated from one another in order to implement, for example, a conventional grid of antenna towers and cells to support a broad area of phone coverage.

The signal processing configuration diagram 200 shows two Base Transceiver Systems (BTS), a Base Transceiver System (BTS) 1 203 and a Base Transceiver System (BTS) 2 205. Channel elements in this illustration, e.g., channel element A 204 and channel element B 206, are each contained in one of these different Base Transceiver Systems. Each Base Transceiver System of one embodiment is able to contain one or more channel elements, but only one channel element is illustrated per Base Transceiver System to simplify understanding of the exemplary embodiment of the present invention.

In one embodiment of the present invention, each channel element includes a collocated cell interface that is adapted to receive RF signals from a respective antenna. The cell interfaces are coupled to respective cell to channel element links 260, which are part of the station-to-BTS RF link described above. The cell to channel element links 260 provide RF connectivity between the BTS channel elements and the antennas. Further embodiments communicate received RF by shifting the RF frequency or communicating a received intermediate frequency.

In one embodiment of the present invention, each BTS channel element has a RAKE receiver that is configured to process received signals to extract user data from multiple, time-delayed, copies of a spread spectrum signal. In one embodiment, the BTS channel element processes received RF signals from multiple sectors, including signals received from antennas located at geographically separated antenna towers. An example of a BTS used in some embodiments of the present invention is a Motorola SC7224, although any suitable BTS or equivalent signal processing equipment is suitable for use by various embodiments of the present invention.

The signal processing configuration diagram 200 shows that the antennas located at several antenna towers are each connected to a single BTS channel element. For example, BTS channel element A 204 is shown to be connected to antennas located at the first antenna tower 210, the second antenna tower 212 and the third antenna tower 214. Similarly, BTS channel element B 206 is connected to antennas located at the fourth antenna tower 216 and the fifth antenna tower 218. In the case of the illustrated embodiment, where each antenna tower has three associated cells, the antenna that is associated with each of the cells for a particular antenna tower has its received RF signals routed to the BTS channel element associated with its antenna tower. In this manner, the RF signals received by antennas located at two or more antenna towers are coupled to a single Base Transceiver System channel element. The single Base Transceiver System channel element then simultaneously processes those RF signals so as to extract user data communicated via those RF signals.

Although the illustrated BTS channel elements are shown to be connected to a particular antenna tower, it is to be understood that the RF connections between antennas located at one or more antenna towers and BTS channel elements is typically routed through RF distribution networks that may include switchable connections to allow a single antenna to supply RF signals to multiple BTS channel elements. Furthermore, multiple BTS channel elements are typically collocated in a particular facility to allow processing of multiple received RF signals from multiple wireless communications devices 104 as are received by one or more antennas.

Each of the BTS channel elements, such as BTS channel element A 204 and BTS channel element B 206 in this embodiment, are connected to a Radio Network Controller (RNC) 108. The RNC 108 of this embodiment performs processing to support operation of this embodiment of the present invention and also perform other supporting operations to control, manage and coordinate communications for wireless communications devices 104. As described above, the RNC 108 of this embodiment is connected to the Public Switched Telephone Network (PSTN) 140 and the Internet 142 to allow communications between wireless communications devices and other devices and/or uses through those networks.

The RNC 108 of the present embodiment includes a call processing function 250 and a configuration database 252. The configuration database 252 stores, among other things, data defining the possible interconnection configurations between the multiple antennas and the multiple BTS channel elements. The call processing function 250 performs, in addition to many of the conventional call processing functions for communications, determinations of which sectors are to be maintained as soft handoff sectors and softer handoff sectors for each wireless communications device over time, as is described in detail below. In some embodiments of the invention, the call processing function 250 determines, based on conventional processing, which cell is the optimal cell to assign to a particular wireless communications device for wireless communications. Further embodiments are able to determine through any suitable method an optimal cell to assign a wireless communication device. The optimal cell to which a particular wireless communications device is assigned is used, for example, to transmit signals from the infrastructure to that wireless communications device. In one embodiment, a single cell is used to transmit signals to a wireless communications device although several cells may be used to simultaneously receive and process signals transmitted by the wireless communications device.

One embodiment of the present invention uses both soft and softer handoffs to maintain communications with the wireless communications device. Soft and softer handoffs simultaneously use two or more cells to communicate with a single wireless communications device. Both soft and softer handoffs result in a diversity benefit that is well understood by one of ordinary skill in the art. Prior art softer handoffs use antenna inputs which are all from the same antenna tower. In contrast to softer handoffs of prior art systems, soft handoffs of the current invention use geographically diverse antenna inputs. The geographically separated inputs show less correlation in their propagation and fading statistics which can lead to a higher diversity gain in systems that process their multiple signals.

In the operation of the illustrated embodiment, the antennas located at the first antenna tower 210, the second antenna tower 212 and the third antenna tower 214 are able to be connected to BTS channel element A 204. This allows the RAKE receiver in BTS channel element A 204 to simultaneously process, at the single Base Transceiver System channel element, the multiple RF signals that correspond to the RF signal originating from a wireless communications device and that are received by some or all of the antennas at these three geographically separated antenna towers. Such a configuration is referred to herein as configuring the wireless communications device for a “softer handoff” between cells since a wireless communications device's transmissions are simultaneously being processed by a single BTS channel element. This allows the uplink path, i.e., the transmission of voice and/or data from the wireless communications device to the infrastructure, to be seamlessly configured for multiple cells, including cells that are associated with geographically separated antenna towers. Further processing by the call processing function 250 determines which cells are suitable to communicate with the wireless communications device. The one or more cells that are suitable to communicate with the wireless communications device are configured to transmit downlink signals from the infrastructure to the wireless communications device. As the wireless communications device moves among cells, the wireless communications device is reassigned to different sectors and those one or more assigned sectors are then used to transmit signals to the wireless communications device. The receive path for transmissions from the wireless communications device has already been configured by the softer handoff processing, thereby increasing the efficiency of handing off a wireless communications device to a new cell.

In contrast to softer handoff processing, soft handoff processing is sometimes used when a system is not able to process received RF signals from geographically separate antenna towers by the same BTS channel element. In soft handoff processing, the different antennas are assigned to different BTS channel elements to simultaneously process the RF signals received by those different cells. For example, when a wireless communications device is in a location where it is able to communicate with two cells but those two cells are not able to have their received RF signals processed by a single BTS channel element, each of these two cells are assigned to a separate BTS channel element in order to be simultaneously processed. Simultaneously processing signals received at two cells from a wireless communications device facilitates transferring the wireless communications device between those two cells, i.e., changing which cell is used to transmit signals to the wireless communications device, as that device moves among the cells.

The signal processing configuration diagram 200 illustrates two examples of a wireless communications device moving between two geographic locations that are within different cells. In a first example, a wireless communications device is illustrated as initially being located at location A 220, which is within cell A 230. The wireless communications device then moves from location A 220 to location B 222, which is within cell B 232. Cell A 230 is associated with the first antenna tower 210 and cell B 232 is associated with the second antenna tower 212. At the initial location A 220, the wireless communications device is within cell A 230 and the optimum cell for communications with this wireless communications device is Cell A 230. The antenna associated with cell A 230 is therefore used to transmit signals to the wireless communications device.

In this particular example, the wireless communications device, while located at location A 220, is able to receive pilot signals associated with cell A 230 and cell B 232. The pilot signal associated with cell A 230 is transmitted from an antenna associated with cell A 230 that is located at the first antenna tower 210 and the pilot signal associated with cell B 232 is transmitted from an antenna associated with cell B 232 that is located at the second antenna tower 212. The wireless communications device reports through a service channel to the RNC 108 that it has received a pilot signal from cell B 232. In response to receiving this notification, the call processing function 250 of the RNC 108 queries the configuration database 252 to determine if cell A 230 and cell B 232 are able to be processed by a single BTS channel element. Because cell A 230 and cell B 232 are able to be processed by a single BTS channel element in this embodiment, the RNC assigns the received RF signals from cell A 230 and from cell B 232 to be processed by the single BTS channel element A 204. BTS channel element A 204 is then configured to process signals originating from this specific wireless communications device, which corresponds to a particular center frequency and spreading code assigned to the wireless communications device in this embodiment. The RAKE receiver within the BTS channel element A 204 of this embodiment then simultaneously processes the received RF signal from cell A 230 and cell B 232 in preparation for handing off the wireless communications device from cell A 230 to cell B 232.

Once the wireless communications device moves to location B 222, cell B 232 is the optimum cell for communications with the wireless communications device. The wireless communications device in this example reports to the RNC 108 that the pilot signal from cell B 232 is stronger than the pilot signal for cell A 230. In response to receiving that report, the RNC 108 assigns the wireless communications device to cell B 232 and cell B 232 is then used to transmit signals to the wireless communications device. At this point, the system is operating in a softer handoff mode and the wireless device simultaneously demodulates, decodes, and combines downlink signals from both sectors, e.g., the sector associated with cell A 230 and cell B 232, while the channel element does the same with the uplink link signals received from the wireless device by the same two sectors. In an example, the RNC instructs both the channel element and wireless device to drop (i.e, stop demodulating, decoding, and combining received signals) the original sector, e.g., the sector associated with cell A 230, once the original sector's pilot signal drops below a configurable threshold. Messaging from the RNC 108 to the Base Transceiver Station and from the RNC to the wireless devices are used to drop sectors and otherwise configure the system components in this example.

In this example, cell A 230 is still able to receive signals from the wireless communications device, and the BTS channel element A 204 is still assigned to process signals received from cell A 230 as well as from cell B 232 in preparation for a possible move by the wireless communications device back into cell A 230.

In a second example of a wireless communications device moving between two cells, a wireless communications device is illustrated as initially being located at location C 224, which is within cell C 238. The wireless communications device then moves from location C 224 to location D 226, which is within cell D 240. Cell C 238 is associated with the third antenna tower 214 and cell D 240 is associated with the fourth antenna tower 216. The wireless communications device was initially within cell C 238 and that cell is used to transmit signals to the wireless communications device.

In this second example, the wireless communications device receives pilot signals associated with cell C 238 and cell D 240, which are transmitted from the third antenna tower 214 and the fourth antenna tower 216, respectively, while it is located at location C 224. The wireless communications device reports to the RNC 108 that it has received a pilot signal from cell D 240. In response to receiving this notification, the call processing function 250 of the RNC 108 queries the configuration database 252 to determine if cell C 238 and cell D 240 are able to be processed by a single BTS channel element. Because cell C 238 and cell D 240 are not able to be processed by a single BTS channel element, the RNC 108 in this example assigns two BTS channel elements to process the signals received by these two cells. The RNC 108 assigns the received RF signals from cell C 238 to be processed by BTS channel element A 204 and the received RF signals from cell D 240 to be processed by BTS channel element B 206. These two BTS channel elements are configured to process signals originating from this specific wireless communications device, which corresponds to a particular center frequency and spreading code in this embodiment. These two BTS channel elements are now simultaneously processing the received RF signal from cell C 238 and cell D 240 in preparation for handing off the wireless communications device between these two cells. This second example, however, uses two BTS channel elements and the RNC 108, in turn, processes the output of these two channel elements.

Once the wireless communications device moves to location D 226, cell D 240 is the optimum cell for communications with the wireless communications device. The wireless communications device is then “handed off” from cell C 238 to cell D 240, in a manner similar to that described above except that two BTS channel elements continue to process the received signals from cell C 238 and cell D 240 in preparation for a possible move by the wireless communications device back into cell C 238.

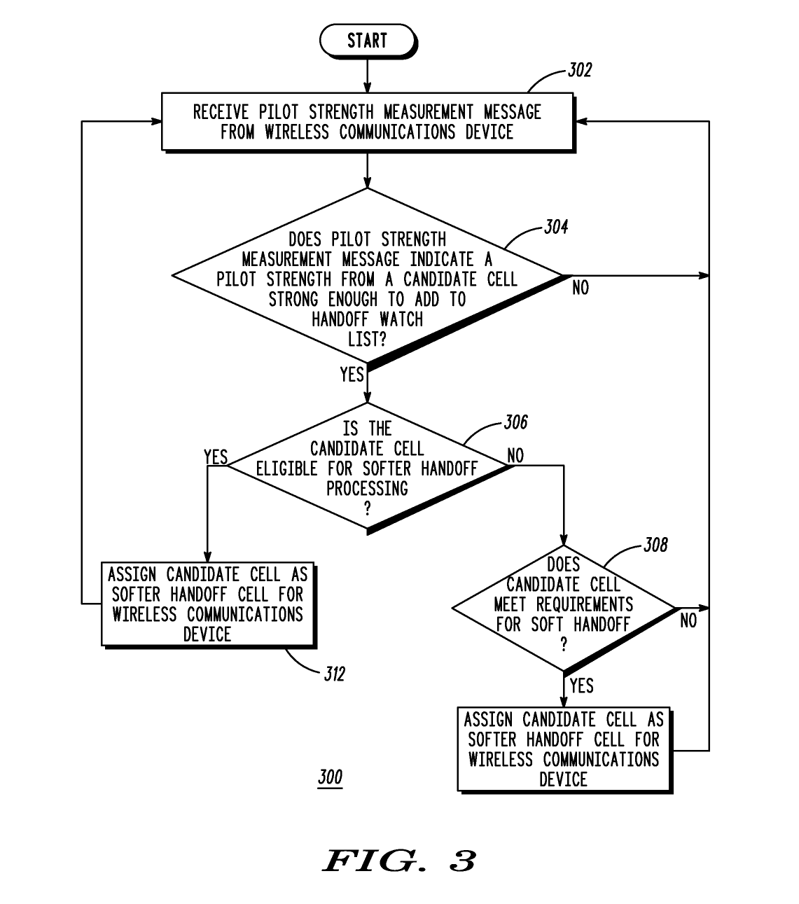

FIG. 3 illustrates a processing flow diagram for a handoff configuration process 300 in accordance with one embodiment of the present invention. The handoff configuration process 300 begins by receiving, at step 302, a Pilot Strength Measurement Message (PSMM) from a wireless communications device. Some embodiments of the present invention use conventional Pilot Strength Measurement Message (PSMM). A Pilot Strength Measurement Message indicates the strength of received pilot signals as measured by the wireless communications device in order to provide an indication of the quality of a communications link between the wireless communications device and the antenna associated with the received pilot signal. Further embodiments of the present invention are able to use any suitable method of determining communications link quality, including, for example, measurements of signal strength that are made at either the wireless communications device, the base station, or at a combination of both.

The handoff configuration process 300 continues by determining, at step 304, if the Pilot Strength Measurement Message indicates that a pilot strength from a candidate cell is strong enough to add to a handoff watch list. A Pilot Strength Measurement Message indicating receipt of a sufficiently strong pilot signal from a cell other than the cell to which the device is assigned indicates that the device is sufficiently close to that cell to support preparing for a handoff to that cell. If the pilot signal measurement message does not indicate a pilot signal is received from anther cell with sufficient strength, the processing returns to receiving, at step 302, a Pilot Strength Measurement Message.

If the received pilot signal measurement message does indicate that a pilot signal has been received from another cell with sufficient strength, the cell associated with this pilot signal becomes a “candidate” cell. This cell is considered a candidate in preparation for a possible handoff of the wireless communications device to that cell. The process continues by determining, at step 306, if the candidate cell is eligible for softer handoff processing. As described above, the candidate cell is eligible for softer handoff processing if the candidate cell is able to be processed by a BTS channel element that is already processing RF signals received by other cells that correspond to RF signals transmitted by the wireless communications device that transmitted the Pilot Strength Measurement Message.

If the candidate cell is determined to be eligible for softer handoff processing, i.e., received signals from the candidate cell can be processed by a BTS channel element that is already processing received signals from the wireless communications device being considered, the processing assigns, at step 312, the candidate cell as a softer handoff cell for the wireless communications device. By assigning the candidate cell as a softer handoff cell, the BTS channel element is configured to simultaneously process the RF signal received by the candidate cell along with another received RF signal, as described above. The processing then returns to receiving, at step 302, a Pilot Strength Measurement Message.

If the candidate cell is not eligible for softer handoff processing, i.e., received signals from the candidate cell cannot be processed by a BTS channel element that is already processing received signals from that wireless communications device being considered, the processing continues by determining, at step 308, if the candidate cell meets requirements for soft handoff processing. As described above, soft handoff processing involves assigning a separate BTS channel element to process signals from the candidate cell. A system may have different requirements, e.g., higher received pilot signal strength, for assigning a cell for a soft handoff since additional hardware resources are required. If the candidate cell does not meet the requirements for being assigned as a soft handoff cell, the processing returns to receiving, at step 302, a Pilot Strength Measurement Message. If the candidate cell does meet the requirements for being assigned as a soft handoff cell, the processing assigns, at step 310, the candidate cell as a soft handoff cell for the wireless communications device by assigning a new BTS channel element to process the received RF signal for the candidate cell. The processing then returns to receiving, at step 302, a Pilot Strength Measurement Message.

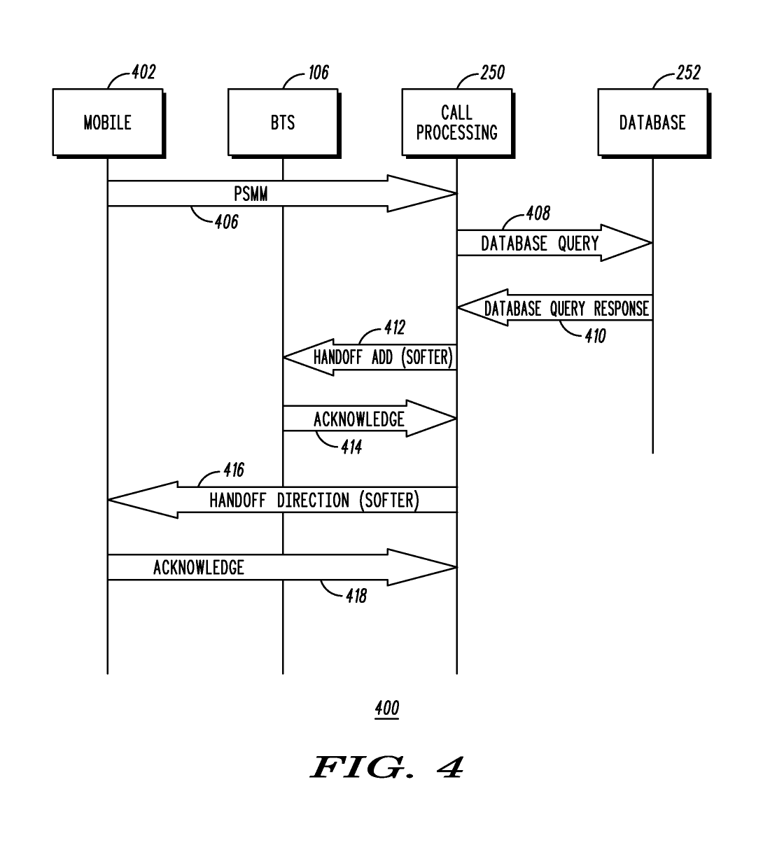

FIG. 4 illustrates a message exchange diagram 400 in accordance with one embodiment of the present invention. The message exchange diagram 400 illustrates control messages and data that are exchanged between the various components of the multiple antenna tower communications system 100. Messages are shown to be exchanged between a mobile device 402, which is a wireless communications device for one embodiment, a BTS 106, which is described above, and the components of the RNC 108, including the call processing function 250 and the configuration database 252, also described above.

The message exchange begins with the mobile device 402 transmitting a Pilot Signal Measurement Message (PSMM) 406 to the call processor function 250 of the RNC 108. As described above, the PSMM 406 is able to contain an indication of the strength of a pilot signal that is received by mobile device 402 from a cell other than the cell to which the mobile device 402 is assigned.

In response to receiving the PSMM 406, the call processor function 250 submits a database query 408 to the database 252 to determine if the pilot signal specified in the PSMM 406 is from a cell that can be processed by a BTS channel element that is already processing the signal transmitted by the mobile device 402 that is received by another cell. In some embodiments of the present invention, this query requests a listing of BTS channel elements that are able to process the RF signals received by the cell transmitting the pilot signal. The configuration database 252 responds to the call processor 250 with a database query response 410 containing information sufficient to allow a determining whether the cell associated with the pilot signal specified by the PSMM 406 can be processed by such a BTS channel element. The call processor function 250 compares the list of BTS channel elements that are able to process the RF signals received by the cell transmitting the pilot signal to the BTS channel elements that are currently assigned to process received RF signals that correspond to transmissions from the mobile device 402. In the case that the cell is eligible for softer handoff processing of the mobile device 402, the call processor 250 sends a handoff add (softer) message 412 to the BTS 106. This causes the BTS 106 to process RF signals from the cell associated with the pilot signal specified by the PSMM 406. The BTS 106 responds with an acknowledge message 414. The call processor 250 then sends a Handoff Direction (softer) message 416 to the mobile device 402. In response to receiving the Handoff Direction (softer) message, the mobile device 402 begins to actively demodulate and decode the traffic channel data (e.g., voice data in the case of a voice call) that is received from the added sector along with the original sector. The mobile responds with an acknowledge message 418 to the call processor function 250.

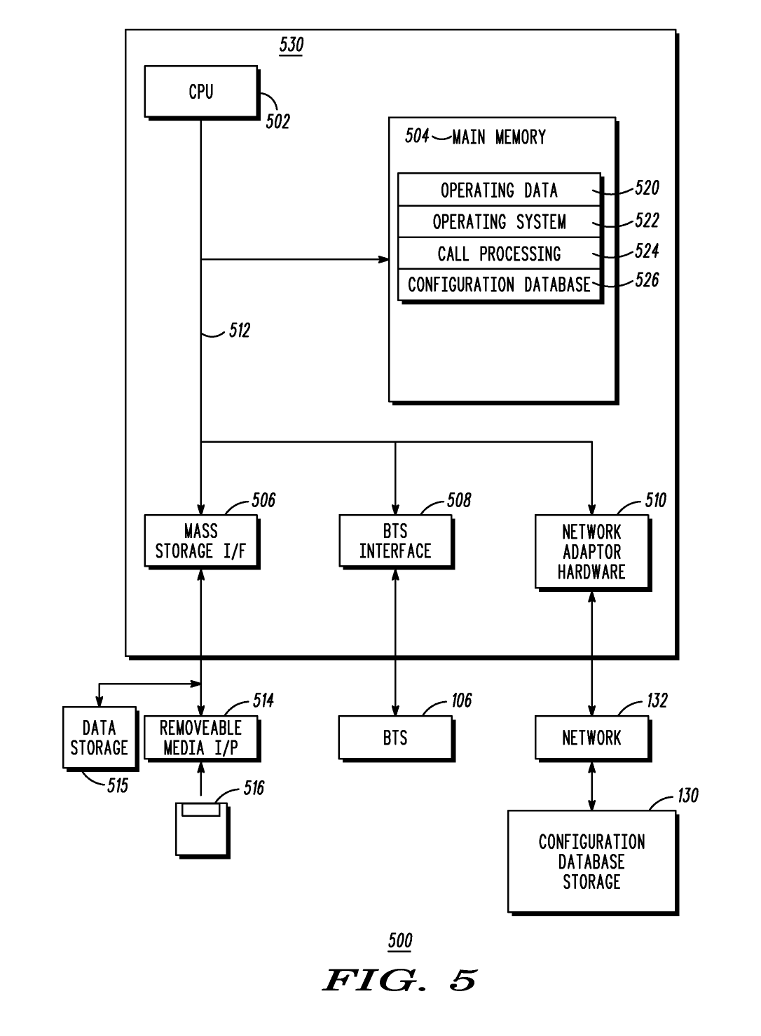

FIG. 5 illustrates a block diagram of a Radio Network Controller (RNC) data processing node 500, in accordance with one embodiment of the present invention. The processing node 500 is based upon a suitably configured processing system adapted to implement an embodiment of the present invention. Any suitably configured processing system is similarly able to be used as a processing node 500 by embodiments of the present invention, for example, an embedded controller, personal computer, computing workstation, or the like. The processing node 500 includes a computer 530. The computer 530 has a Central Processing Unit (CPU) 502 that is connected to a main memory 504, mass storage interface 506, BTS interface 508, and network adapter 510. A system bus 512 interconnects these system components.

The mass storage interface 506 is used to connect data storage devices, such as removable media interface 514 and data storage 515, to the computer 530. One specific type of removable media interface 514 is a computer readable medium interface such as a floppy disk drive, DVD/CD reader, memory card reader, or the like, which are able to be used to store data to and read data from compatible removable media 516, such as a floppy disk or memory card. Data storage 515 includes a non-removable data storage device configured to support, for example, data storage using a suitable disk file system operating system.

The main memory 504 includes operating data 520 that is used by CPU 502 to maintain the current operating state of the RNC 108. The operating data 520 is able to contain, for example, a listing of wireless communications devices, the cell to which each wireless communications device is assigned, and other cells that are processing received signals from each wireless communications device for either soft handoff processing or softer handoff processing.

An operating system 522 included in the main memory is a suitable computer operating system. Embodiments of the present invention are able to use any other suitable computer operating system. Some embodiments of the present invention utilize architectures, such as an object oriented framework mechanism, that allows instructions of the components of operating system 522 to be executed on any processor located within the computer 530.

Main memory 504 further contains a call processing program 524. The call processing program includes machine readable instructions that are processed by CPU 502 to implement the functions of the call processing function 250. Main memory 504 also contains a configuration database program 526. The configuration database program performs processing required to query and maintain the configuration database storage 130 and to return information from query responses to other processing performed by CPU 530.

Although illustrated as concurrently resident in the main memory 504, it is clear that respective components within the main memory 504 are not required to be completely resident in the main memory 504 at all times or even at the same time. In one embodiment, the computer 530 utilizes conventional virtual addressing mechanisms to allow programs to behave as if they have access to a large, single storage entity, referred to herein as a computer system memory, instead of access to multiple, smaller storage entities such as the main memory 504 and data storage device 515. Note that the term “computer system memory” is used herein to generically refer to the entire virtual memory of the computer 530.

BTS interface 508 provides data connectivity from the computer 530 to the multiple Base Transceiver Systems (BTS) and their channel elements. Although only one BTS 106 is shown for clarity and ease of understanding, it is to be understood that a RNC data processing node 500 is in communication with many BTS channel elements that are able to be either collocated with the RNC data processing node 500, all located at a single remote location, and/or distributed among multiple locations.

The network adapter hardware 510 is used to provide an interface to the network 132 that is used to communicate data between the RNC 108 and other components of the infrastructure. The RNC 108, and computer 530 in particular, communicates via the network 132 in some embodiments with a configuration database storage 130. The configuration database storage stores the data sets that are accessed by the configuration database program 526. The configuration database storage 130 is located remotely in some embodiments to support distributed location of various RNC elements. Further embodiments of the present invention are able to operate with a configuration database storage that is maintained by computer 530 or with a local copy of the configuration database storage 130. Embodiments of the present invention are able to be adapted to work with any data communications connections including present day analog and/or digital techniques or via a future networking mechanism.

Although only one CPU 502 is illustrated for computer 530, computer systems with multiple CPUs can be used equally effectively. Embodiments of the present invention further incorporate interfaces that each includes separate, fully programmed microprocessors that are used to off-load processing from the CPU 502.

Although some embodiments of the present invention are described in the context of a fully functional computer system, those skilled in the art will appreciate that embodiments are capable of being distributed as a program product via floppy disk, e.g. floppy disk 516, CD ROM, or other form of recordable media, or via any type of electronic transmission mechanism.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for processing transmitted signals that are received at geographically separated antenna towers, the method comprising:
receiving a first RF signal with at least one first antenna associated with a first cell, the first antenna being located at a first antenna tower;
receiving a second RF signal with at least one second antenna associated with a second cell, the second antenna being located at a second antenna tower that is geographically separated from the first antenna tower, the first RF signal and the second RF signal corresponding to a common RF signal containing user data transmitted by a wireless communications device;
coupling the first RF signal and the second RF signal to a single Base Transceiver System channel element; and
simultaneously processing, at the single Base Transceiver System channel element, the first RF signal and the second RF signal so as to extract the user data transmitted by the wireless communications device.

2. The method of claim 1, further comprising:
assigning the wireless communications device to the first cell; and
re-assigning, while simultaneously processing the first RF signal, the wireless communications device to the second cell.

3. The method of claim 1, wherein the simultaneously processing comprises processing of the first RF signal and of the second RF signal by single RAKE receiver.

4. The method of claim 1, further comprising:
determining, while receiving the first RF signal, that the wireless communications device is receiving a signal from the second antenna tower with a received signal strength that exceeds a threshold; and
determining that the second cell is able to be processed by the single Base Transceiver System channel element,
wherein the simultaneous processing is performed in response to determining that the second cell is able to be processed by the single Base Transceiver System channel element.

5. The method of claim 1, wherein the coupling comprises communication of the second RF signal over at least one of a fiber optic link and a wireless link.

6. The method of claim 1, further comprising:
maintaining a database of cells associated with antennas that can be processed by a common Base Transceiver System channel element;
receiving, from the wireless communications device while receiving the first RF signal, a signal indicating reception by the wireless communications device of a pilot signal from a third antenna associated with a third cell;
determining, based upon data maintained in the database, that the third cell is able to be processed by the single Base Transceiver System channel element,
coupling a third RF signal received by the third antenna to the single Base Transceiver System channel element, the third RF signal corresponding to the common RF signal containing user data transmitted by a wireless communications device; and
simultaneously processing, in response to the determining that the third cell is able to be processed by the single Base Transceiver System channel element, at least the first RF signal and the third RF signal at the single Base Transceiver System channel element so as to extract the user data transmitted by the wireless communications device.

7. The method of claim 6, further comprising:
determining, based upon data maintained in the database, that the third cell is not able to be processed by the single Base Transceiver System channel element; and
assigning, in response to determining that the second cell is not able to be processed by the single Base Transceiver System channel element, the second RF antenna to another Base Transceiver System channel element for soft handoff processing.

8. A cell handoff signal processing system, comprising:
a first cell interface adapted to receive a first RF signal that was received by at least one first antenna associated with a first cell, the first antenna being located at a first antenna tower;
a second cell interface adapted to receive a second RF signal that was received by at least one second antenna associated with a second cell, the second antenna being located at a second antenna tower that is geographically separated from the first antenna tower, the first RF signal and the second RF signal corresponding to a common RF signal containing user data transmitted by a wireless communications device; and
at least one single base transceiver channel element, coupled to and collocated with the first cell interface and the second cell interface, adapted to simultaneously process the first RF signal and the second RF signal so as to extract the user data transmitted by the wireless communications device.

9. The cell handoff signal processing system of claim 8, further comprising a call processor, coupled to the at least one single base transceiver channel element, the call processor adapted to:
assign the wireless communications device to the first cell; and
re-assign, while the at least one single base transceiver channel element is simultaneously processing the first RF signal, the wireless communications device to the second cell.

10. The cell handoff signal processing system of claim 8, further comprising a call processor, coupled to the at least one single base transceiver channel element, the call processor adapted to:
determine that the wireless communications device is receiving a signal from the second antenna tower with a received signal strength that exceeds a threshold; and
determine that the second cell is able to be processed by the single Base Transceiver System channel element,
wherein the at least one single base transceiver channel element is adapted to simultaneously process the first RF signal and the second RF signal in response to determining that the second cell is able to be processed by the single Base Transceiver System channel element.

11. The cell handoff signal processing system of claim 8, further comprising a cell to channel element link, the cell to channel element link comprising at least one of a fiber optic link and a wireless link, the cell to channel element link adapted to couple at least one of the first RF signal to the first cell interface and the second RF signal to the second cell interface.

12. The cell handoff signal processing system of claim 8, further comprising:
a configuration database adapted to maintain a database of cells associated with antennas that can be processed by a common Base Transceiver System channel element; and
a call processor, coupled with the configuration database and the at least one single base transceiver channel element, the call processor adapted to:
receive, from the wireless communications device, a signal indicating reception by the wireless communications device of a pilot signal from a third antenna associated with a third cell;
determine, based upon data maintained in the configuration database, that the third cell is able to be processed by the single Base Transceiver System channel element; and
command, in response to determining that the third cell is able to be processed by the single Base Transceiver System channel element, the single Base Transceiver System channel element to process a third RF signal received by the third antenna, the third RF signal corresponding to the common RF signal containing user data transmitted by a wireless communications device,
wherein the single Base Transceiver System channel element simultaneously processes, in response to the call processor's commanding, at least the first RF signal and the third RF signal at the single Base Transceiver System channel element so as to extract the user data transmitted by the wireless communications device.

13. The cell handoff signal processing system of claim 12, wherein the call processor is further adapted to:
determine, based upon data maintained in the database, that the third cell is not able to be processed by the single Base Transceiver System channel element; and
assign, in response to determining that the second cell is not able to be processed by the single Base Transceiver System channel element, the second RF antenna to another Base Transceiver System channel element for soft handoff processing.

14. A machine-readable medium encoded with a program for processing transmitted signals that are received at geographically separated antenna towers, the program comprising instructions for:
receiving a first RF signal with at least one first antenna associated with a first cell, the first antenna being located at a first antenna tower;
receiving a second RF signal with at least one second antenna associated with a second cell, the second antenna being located at a second antenna tower that is geographically separated from the first antenna tower, the first RF signal and the second RF signal corresponding to a common RF signal containing user data transmitted by a wireless communications device;
coupling the first RF signal and the second RF signal to a single Base Transceiver System channel element; and
simultaneously processing, at the single Base Transceiver System channel element, the first RF signal and the second RF signal so as to extract the user data transmitted by the wireless communications device.

15. The machine readable medium of claim 14, further comprising instructions for:
assigning the wireless communications device to the first cell; and
re-assigning, while simultaneously processing the first RF signal and the second RF signal, the wireless communications device to the second cell.

16. The machine readable medium of claim 14, further comprising instructions for:
determining, while receiving the first RF signal, that the wireless communications device is receiving a signal from the second antenna tower with a received signal strength that exceeds a threshold; and
determining that the second cell is able to be processed by the single Base Transceiver System channel element,
wherein the simultaneous processing is performed in response to determining that the second cell is able to be processed by the single Base Transceiver System channel element.

17. The machine readable medium of claim 14, further comprising instructions for:
maintaining a database of cells associated with antennas that can be processed by a common Base Transceiver System channel element;
receiving, from the wireless communications device while receiving the first RF signal, a signal indicating reception by the wireless communications device of a pilot signal from a third antenna associated with a third cell;
determining, based upon data maintained in the database, that the third cell is able to be processed by the single Base Transceiver System channel element,
coupling a third RF signal received by the third antenna to the single Base Transceiver System channel element, the third RF signal corresponding to the common RF signal containing user data transmitted by a wireless communications device; and
simultaneously processing, in response to the determining that the third cell is able to be processed by the single Base Transceiver System channel element, at least the first RF signal and the third RF signal at the single Base Transceiver System channel element so as to extract the user data transmitted by the wireless communications device.

18. The machine readable medium of claim 17, further comprising instructions for:
determining, based upon data maintained in the database, that the third cell is not able to be processed by the single Base Transceiver System channel element; and
assigning, in response to determining that the second cell is not able to be processed by the single Base Transceiver System channel element, the second RF antenna to another Base Transceiver System channel element for soft handoff processing.
